(19) United States
(12) Patent Application Publication
(10) Pub. No.: US 2024/0112687 A1
(43) Pub. Date: Apr. 4, 2024

(54) GENERATING AUDIO FILES FROM TEXT INPUT

(71) Applicant: Meta Platforms Technologies, LLC, Menlo Park, CA (US)

(72) Inventors: Yaniv Nechemia Taigman, Raanana (IL); Felix Kruk, Rehovot (IL); Yossef Mordechay Adi, Rishon Le Zion (IL); Gabriel Synnaeve, Paris (FR); Adam Polyak, Tel Aviv (IL); Uriel Singer, Harish (IL); Devi Niru Parikh, San Francisco, CA (US); Alexandre Défossez, Paris (FR); Jade Copet, Paris (FR)

(21) Appl. No.: 18/477,859

(22) Filed: Sep. 29, 2023

Related U.S. Application Data
(60) Provisional application No. 63/411,536, filed on Sep. 29, 2022.

(51) Int. Cl. G10L 19/018; G10L 19/02

(52) U.S. Cl. CPC G10L 19/018; G10L 19/0204

(57) ABSTRACT

Methods, systems, and storage media for generating audio data includes receiving a text input. The method also includes receiving a plurality of representative audio sources and encoding the plurality of representative audio sources into a plurality of audio tokens. The method includes encoding the text input into a plurality of text representations. The method comprises mapping each audio tokens of the plurality of audio tokens to a text representation of the plurality of text representations. The method also comprises determining a relationship score based on mapping each audio tokens to the text representation, wherein the relationship score identifies a distribution of audio tokens from the plurality of audio tokens. The method and systems can also comprise decoding the subgroup of audio tokens to yield a reconstructed audio source.

### CROSS REFERENCE TO RELATED APPLICATIONS

This application claims priority under 35 U.S.C. § 119(e) to U.S. patent application Ser. No. 63/411,536 filed Sep. 29, 2022, the disclosures of which applications are incorporated by reference herein, in their entirety, for all purposes.

### TECHNICAL FIELD

The present disclosure generally relates to generating audio files for a virtual/augmented reality environment, and more particularly the generating audio files from a receive text input.

### BACKGROUND

Developing a virtual/augmented environment can require visual and audio elements to enhance the user experience. Audio generation for an environment can pose certain difficulties. Audio is intrinsically a one dimensional signal and thus has less degrees of freedom to differentiate multiple sounds. For example, when experiencing the sounds of an outside cityscape, there can be a plurality of sounds. However at a singular instance in time, differentiating the various sounds of the city scape would be difficult to decipher and/or distinguish. Further, the availability of audio data with textual descriptions is not as available in comparison to text-image paired data.

### BRIEF SUMMARY

The subject disclosure provides for method for generating audio data for use in a virtual and augmented environment. The method can comprise receiving a text input from an input device such as keyboard or virtual reality headset. The method can include receiving a plurality of representative audio sources. The method can include encoding the plurality of representative audio sources into a plurality of audio tokens. The method can include encoding the text input into a plurality of text representations. The method can include mapping each audio token of the plurality of audio tokens to a text representation of the plurality of text representations. The method can include determining a relationship score based on mapping each audio token to the text representation, wherein the relationship score identifies a distribution of audio tokens from the plurality of audio tokens. The method can include in response on the relationship score, determining a subgroup of audio tokens from the distribution of audio tokens. The method can also include decoding the subgroup of audio tokens to yield a reconstructed audio source.

One aspect of the present disclosure relates to system for generating audio data. The system can include processors and a memory. The memory can include machine readable instructions. The processors execute instructions to receive a text input from an input device such as a keyboard or virtual reality headset. The processors execute instructions to receive a plurality of representative audio sources. The processors execute instructions to encode the plurality of representative audio sources into a plurality of audio tokens. The processors execute instructions to encode the text input into a plurality of text representations. The processors execute instructions to map each audio token of the plurality of audio tokens to a text representation of the plurality of text representations. The processors execute instructions to determine a relationship score based on mapping each audio token to the text representation, wherein the relationship score identifies a distribution of audio tokens from the plurality of audio tokens. The processors execute instructions to determine a subgroup of audio tokens from the distribution of audio tokens. The processors execute instructions to decode the subgroup of audio tokens to yield a reconstructed audio source.

Another aspect of the present disclosure relates to a non-transitory computer-readable storage medium having instructions embodied thereon, the instructions being executable by one or more processors to perform a method for generating audio data. The method can comprise receiving a text input from an input device such as a keyboard or virtual reality headset. The method can include receiving a plurality of representative audio sources. The method can include encoding the plurality of representative audio sources into a plurality of audio tokens. The method can include encoding the text input into a plurality of text representations. The method can include mapping each audio token of the plurality of audio tokens to a text representation of the plurality of text representations. The method can include determining a relationship score based on mapping each audio token to the text representation, wherein the relationship score identifies a distribution of audio tokens from the plurality of audio tokens. The method can include in response on the relationship score, determining a subgroup of audio tokens from the distribution of audio tokens. The method can also include decoding the subgroup of audio tokens to yield a reconstructed audio source.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an overview of an environment in which some implementations of the disclosed technology can operate.

FIG. 2 illustrates a block diagram depicting an audio generation process, in accordance with one or more implementations.

FIG. 3 illustrates a system configured for generating audio files from text input, i according to certain aspects of the disclosure.

FIG. 4 illustrates an example flow diagram for generating audio files from text input, according to certain aspects of the disclosure.

FIG. 5 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The technical problem addressed in this disclosure focuses on generating audio samples conditioned on descriptive text captions. In generating audio content, the systems and methods should produce three categories of acoustic content, with varying degrees of background/foreground, durations, and relative position in the temporal axis. Addressing the technical problem of the disclosure can comprise two stages. The first stage can include encoding raw audio to a discrete sequence of audio tokens using a compression model. A raw audio file is any file containing un-containerized and uncompressed audio. In differentiating this disclosure from the other solutions, the disclosure can determine an audio representation based on model training of compression/decompression of raw audio in wave form. In one aspect, the compression model can comprise a neural audio compression model. The model can be trained in an end-to-end fashion to decompress and reconstruct the input audio from the compressed representation. The audio representation is designed to generate high-fidelity audio samples while still being compact. The second stage of addressing the technical problem comprises leveraging an autoregressive transformer-decoder language-model that operates on the audio tokens obtained from the first stage while also being conditioned on textual inputs. A pre-trained text encoder can enable the generalization to text concepts that are absent from current text-audio datasets.

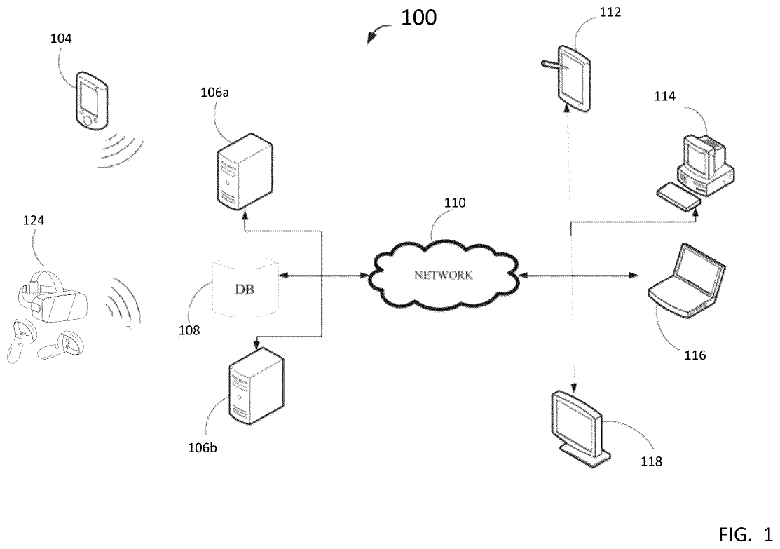

FIG. 1 is a block diagram illustrating an overview of an environment 100 in which some implementations of the disclosed technology can operate. The environment 100 can include one or more client computing devices, mobile device 104, tablet 112, personal computer 114, laptop 116, desktop 118, virtual reality headset 1124 and/or the like. Client devices may communicate wirelessly via the network 110. The client computing devices can operate in a networked environment using logical connections through network 110 to one or more remote computers, such as server computing devices. The server computing devices 106a-106b may be configured to show (e.g., make encrypted content visible) content to one or more of the client computing devices for those client computing devices that presented a correct public key.

In some implementations, the environment 100 may include a server such as an edge server which receives client requests and coordinates fulfillment of those requests through other servers. The server may include the server computing devices 106a-106b, which may logically form a single server. Alternatively, the server computing devices 106a-106b may each be a distributed computing environment encompassing multiple computing devices located at the same or at geographically disparate physical locations. The client computing devices and server computing devices 106a-106b can each act as a server or client to other server/client device(s). The server computing devices 106a-106b can connect to a database 108 or can comprise its own memory. Each server computing devices 106a-106b can correspond to a group of servers, and each of these servers can share a database 108 or can have their own database 108. The database 108 may logically form a single unit or may be part of a distributed computing environment encompassing multiple computing devices that are located within their corresponding server, located at the same, or located at geographically disparate physical locations.

The network 110 can be a local area network (LAN), a wide area network (WAN), a mesh network, a hybrid network, or other wired or wireless networks. The network 110 may be the Internet or some other public or private network. Client computing devices can be connected to network 110 through a network interface, such as by wired or wireless communication. The connections can be any kind of local, wide area, wired, or wireless network, including the network 110 or a separate public or private network.

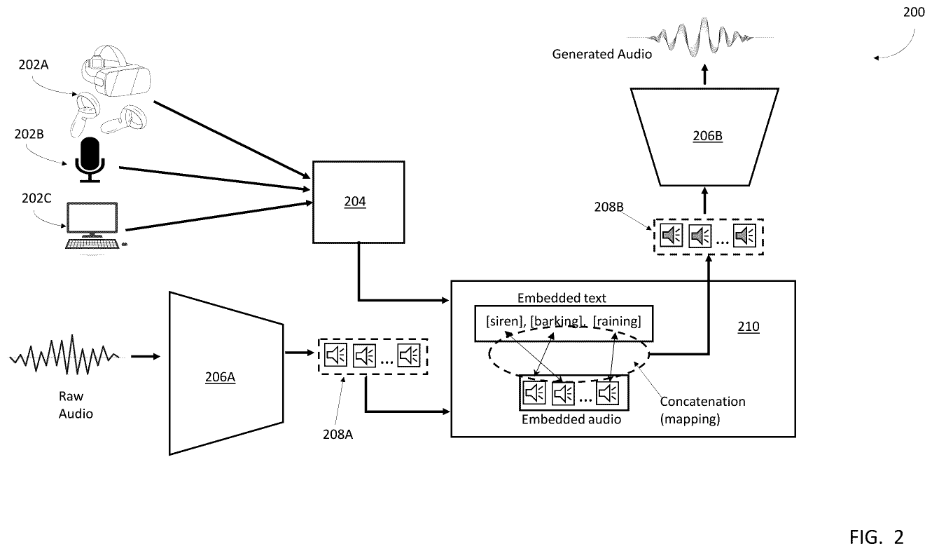

FIG. 2. illustrates a system 200 for audio generation. The system and method are configured to provide text input that can be used to generate audio. The input devices 202A, 202B, 202C for the text input can comprise a virtual reality headset 202A, a microphone 202B, a computing device 202C. In alternative embodiments, other input devices can be implemented that can provide an input signal for conversion to a text input. The system 200 can comprise a text encoder 204. The text encoder 204 can receive the input from the input device and convert the varying input into a text input. In a further aspect, the text encoder can be pretrained to more efficiently convert the inputs from the input devices 202A-C into text data. This system 200 can also include an audio representation device. The audio representation device can comprise two components: an audio encoder 206A and audio decoder 206B. The audio encoder 206A can comprise a transmission type element on a computing device configured to receive raw audio data. In a further aspect, the raw audio file can come from an external source (e.g. a database). The audio encoder 206A can comprise a quantization model that operates on the received audio file to compress the audio file into an audio representation in the form of audio tokens 208A. In a further aspect, the quantization model operating through the audio encoder can complete multiple iterations of convolutions to compress the raw audio files into audio tokens 208A.

The system can also include a transformer decoder element 210; the transformer decoder can receive the text inputs from the text encoder 204 and the audio tokens 208A from the audio encoder 206A. In one aspect the text input derived from the text encoder 204 and the audio tokens can be concatenated to create a mapping between textual representations determined from the text inputs. In a further aspect, the strength of the linkage between the text representations and audio tokens can be enhanced, yielding a generated audio that is closer to the desired audio signal from the text inputs received from the input devices 202A-202C. For example, the linkages in the mapping can be enhanced by implementing cross-attention between audio and text to an attention block operating in the transformer decoder 210.

As mentioned earlier the audio representation model can also comprise an audio decoder 206B. After the transformer decoder 206B has generated a linkage between the textual representation and audio tokens 208B associated with the textual representation, the transformer decoder 206B can output an audio waveform associated with the desired soundscape or audio sound. The audio tokens 208B can then be processed by the audio decoder such that the audio decoder 206B can expand the compressed audio tokens 208A into a reconstructed audio wave form in the time and frequency domains yielding the desired sound output to be received into a virtual or augmented reality environment.

Similar to the audio encoder 206A, the audio decoder 206B can comprise a quantization layer configured to operate on the concatenated audio tokens 208B. Through multiple convolutions the decoder can decompress the concatenated audio tokens and reconstruct the time domain signal of a generated audio file. The audio decoder 206B mirrors the audio encoder 206A using transposed convolutions from the encoding convolutions to output the reconstructed audio. In a further aspect, the audio encoder 206A and decoder 206B can be trained to minimize the reconstruction loss applied over both time and frequency and also minimize perception loss by implementing discriminators.

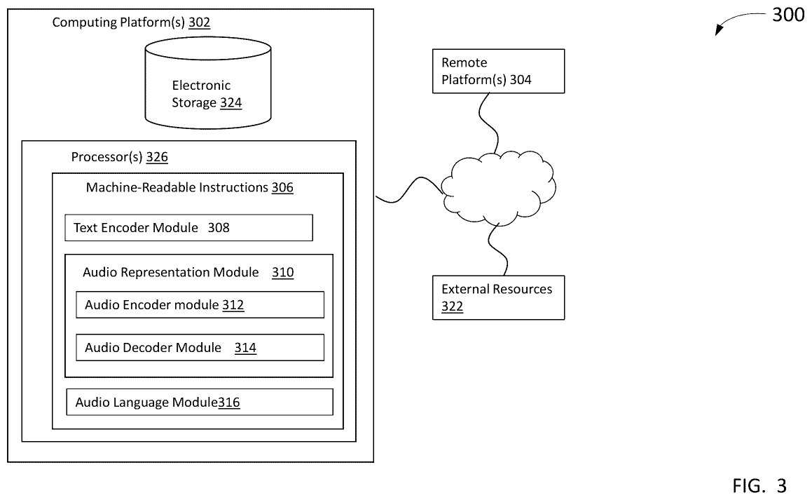

FIG. 3 illustrates a system 300 configured for generating audio data, according to certain aspects of the disclosure. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

Computing platform(s) 302 may be configured by machine-readable instructions 306. Machine-readable instructions 306 may include one or more instruction modules. The instruction modules may include computer program modules. The instruction modules may include one or more of a text encoder module 308, audio representation module 310, and audio language module 316 and/or other instruction modules.

The text encoder module 308 can be used to generate text from either direct text input or convert audio input into text input. In a further aspect, the text encoder module 308 can be configured to also receive text structured as sentences and paragraphs. Further, the text encoder module 308 can be configured to generate a semantic representation from the text input structured as singular words, sentences or paragraphs. These semantic representations of the text input can be concatenated with audio tokens by the audio language module 316. In one aspect, the text encoder module 308 can be pretrained. The audio representation module 310 may be configured with two submodules that perform functions on the input audio file, the audio encoder module 312 and audio decoder module 314. The audio encoder module 312 can be configured to convert the raw audio signal from an audio source to a compressed file grouped into a plurality of audio tokens. For example the audio source may come from an external source 328 or locally in electronic storage 330. The audio token can comprise the components of the raw wave form of an audio file such that the token can be mapped to the semantic representation of the input text. For example, the raw wave file can be received from a database wherein the raw wave file is 100 MB, the associated audio token can be 1 MB. To compress the raw audio file to an audio token, the audio encoder module 312 executes a series of convolutions to compress and parse the raw wave data into audio tokens. To decompress the audio token to a reconstructed audio file, the audio decoder module 314 executes a series of transposed convolutions to decompress the audio token and convert to an audio file (e.g. way. file). During encoding or decoding, the reconstructed audio signal can have losses in both the time domain and the frequency domain. To reduce these losses during encoding and decoding, the audio representation module 310 can implement a neural network. In one aspect, the neural network can be a Generative Adversarial Network (GAN). Further, to improve the reconstructed audio, the audio encoder module 312 or audio decoder module 314 can implement a multi-scale short-time Fourier transform (MS-STFT) discriminators to improve the quality of a signal. The MS-STFT discriminator can be based on identically structured networks operating on multi-scaled complex valued STFT where its real and imaginary parts are concatenated.

The audio language module 316 may be configured to aid in generating the resultant audio for use in an VR/AR environment. In one aspect, the audio language module may operate on the text and audio inputs received at the transformer encoder 210. The audio language module 316 can receive the textual input from the input devices via the text encoder as a semantic representation. The audio tokens representing the raw audio and the semantic text representations of the text input can be linked together by concatenating these two groups of input. For example, the audio token can comprise a 2 millisecond representation of raw audio and the semantic representation. In one aspect, the semantic representation can comprise a word or group of words that is a probabilistic parsing of a larger grouping of words. The strength and validity of the linkage (mapping) between the audio tokens and the semantic text representations can be calculated by a score and continuously fed into a regression model operating in the audio language module 316 to improve the linkage between an associated audio token and the semantic text representation. The associated score can comprise a probability distribution that the audio token is consistent with the semantic text representation. To achieve a better text adherence, the linkage between the semantic text representation and the audio token can comprise cross-attention between audio and text to each attention block.

In a further aspect, the system 300 can execute the machine language 306 in two stages, a training stage executed via the audio representation module 310 and an audio generation stage via audio language module 316. During the first stage, the audio representation module 310 can receive raw audio files from a plurality of external or internal saved sources. Audio representation module can run a training model with the purpose of encoding the raw audio file by compressing the raw audio file into a plurality of audio tokens and then decompressing the audio tokens into an audio signal. The training stage defines the manner in which the audio signal should be encoded and decoded to both extract the audio tokens and yield minimal differences in the initial raw audio file and the decoded output audio file, resulting from the training process. The training phase can compare the accuracy of the output audio file after encoding and decoding the raw audio file. Also the audio representation module can implement a multi-scale short-time Fourier transform (MS-STFT) discriminators to improve the quality of an audio signal.

During the second phase, the transformer decoder operating via the audio language module 316 can use the audio tokens previously determined from the training phase. The audio language module 316 can map semantic text representations to the audio tokens. The language module 316 can then predict which audio tokens can be decoded (decompressed) to generate the desired audio output. The prediction of a grouping of audio tokens to be used in the reconstructed audio generation can be based on a relationship score. The relationship score can comprise objective and/or subjective components. The objective analysis of the relationship score can be the result of an audio classification model computing a label distribution produced by a pre-trained text classifier (e.g. the KL-Divergence). In a further aspect, functions used in the audio classification model can comprise at least one of the Frechet Audio Distance (FAD) and/or the subjective analysis can comprise external evaluators providing a scaled numerical analysis of the similarity score between a text input and a sampled audio output. In a further aspect, the results of the subjective components can be a primer (starter) input provided to the model generating the objective components of the relationship score.

The audio language model can refine the prediction of the appropriate audio tokens by rerunning a model to update a relationship score defined by the mapping between the text representations of the text input and the audio tokens identified from the training stage. The audio classification model can via the objective and/or subjective components, predict a distribution of audio tokens that will be representative of the text input. The audio language model can be configured to operate as a regression model to optimize the distribution, and thus identify the resultant audio tokens optimized to yield the closest reconstructed audio signal to the initial text input. Once the optimized appropriate audio tokens are identified and decoded via the audio decoder module, the reconstructed audio file for use can be generated.

In some implementations, computing platform(s) 302, remote platform(s) 304, and/or external resources 322 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 322 may be operatively linked via some other communication media.

A given remote platform 304 may include one or more processors configured to execute computer program modules. The computer program modules may be configured to enable an expert or user associated with the given remote platform 304 to interface with system 300 and/or external resources 322, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 322 may include sources of information outside of system 300, external entities participating with system 300, and/or other resources. In some implementations, some or all of the functionality attributed herein to external resources 322 may be provided by resources included in system 300.

Computing platform(s) 302 may include electronic storage 324, one or more processors 326, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 324 may comprise non-transitory storage media that electronically stores information. The electronic storage media of electronic storage 324 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 324 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 324 may include one or more virtual storage resources (e.g., cloud storage, a virtual private network, and/or other virtual storage resources). Electronic storage 324 may store software algorithms, information determined by processor(s) 326, information received from computing platform(s) 302, information received from remote platform(s) 304, and/or other information that enables computing platform(s) 302 to function as described herein.

Processor(s) 326 may be configured to provide information processing capabilities in computing platform(s) 302. As such, processor(s) 326 may include one or more of a digital processor, an analog processor, a digital circuit designed to process information, an analog circuit designed to process information, a state machine, and/or other mechanisms for electronically processing information. Although processor(s) 326 is shown in FIG. 3 as a single entity, this is for illustrative purposes only. In some implementations, processor(s) 326 may include a plurality of processing units. These processing units may be physically located within the same device, or processor(s) 326 may represent processing functionality of a plurality of devices operating in coordination. Processor(s) 326 may be configured to execute modules 308, 310, 312, 314, and/or 316 other modules. Processor(s) 326 may be configured to execute modules 308, 310, 312, 314, and/or 316, and/or other modules by software; hardware; firmware; some combination of software, hardware, and/or firmware; and/or other mechanisms for configuring processing capabilities on processor(s) 326. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, and/or 316, are illustrated in FIG. 3 as being implemented within a single processing unit, in implementations in which processor(s) 326 includes multiple processing units, one or more of modules 308, 310, 312, 314, and/or 316, may be implemented remotely from the other modules. The description of the functionality provided by the different modules 308, 310, 312, 314, and/or 316, described below is for illustrative purposes, and is not intended to be limiting, as any of modules 308, 310, 312, 314, and/or 316, may provide more or less functionality than is described. For example, one or more of modules 308, 310, 312, 314, and/or 316, may be eliminated, and some or all of its functionality may be provided by other ones of modules 308, 310, 312, 314, and/or 316. As another example, processor(s) 326 may be configured to execute one or more additional modules that may perform some or all of the functionality attributed below to one of modules 308, 310, 312, 314, and/or 316.

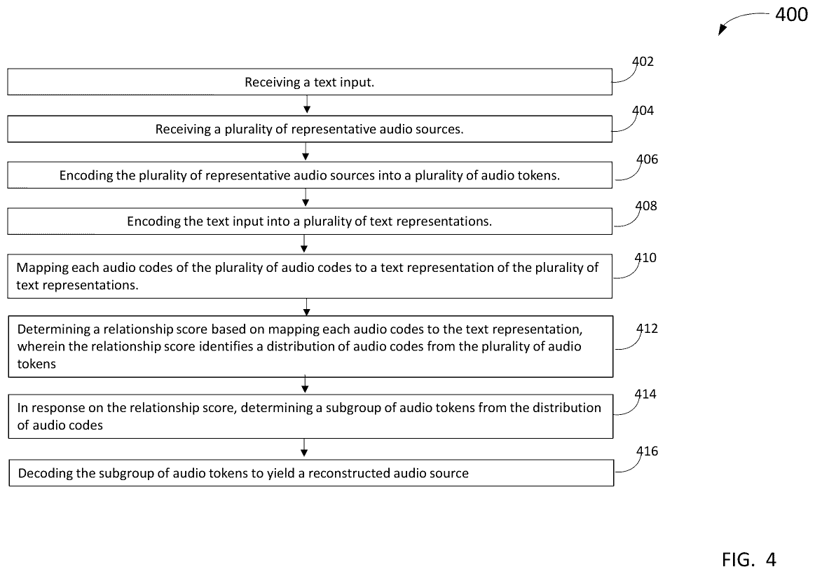

FIG. 4 illustrate an example flow diagram (e.g. process 400) for generating audio. For explanatory purposes, the example process 400 is described herein with reference to FIGS. 1-3. Further for explanatory purposes, the steps of the example process 400 are described herein as occurring in serial, or linearly. However, multiple instances of the example process 500 may occur in parallel.

At step 402, the process can include receiving a text input. In one aspect, the text can be received from an input device of a computing device. In another aspect, the text input can be received from an audio file that has been converted to text by a pretrained model. At step 404, the process can include receiving a plurality of representative audio sources. In a further aspect, the representative audio sources can be stored in an internal storage device or received from an external storage device. At step 406, the process can include encoding the plurality of representative audio sources into a plurality of audio tokens. In an aspect, encoding the representative audio sources can comprise compressing the representative audio by performing successive convolution functions on the audio data to reduce the audio data's file size. At step 408, the process can include encoding the text input into a plurality of text representations. In an aspect, encoding the text data can comprise parsing the text input into a semantic representations. In yet a further aspect, the encoded text data can be embedded using a Look-Up-Table.

At step 410, the process can include mapping each audio tokens of the plurality of audio tokens to a text representation of the plurality of text representations. In an aspect, mapping the audio token with the text representation can comprise executing a model that embeds the text representation and audio tokens in a continuous space to concatenate the text and audio. At step 412, the process can include determining a relationship score based on mapping each audio tokens to the text representation. The relationship score identifies a distribution of audio tokens from the plurality of audio tokens. The determination of the relationship score can be calculated via a model such that the model continues to update the results, providing an enhanced linkage between the text data and predicted audio data. At step 414, the process includes, determining a subgroup of audio tokens from the distribution of audio tokens. In one aspect, select grouping of the entire set of audio tokens can be used to identify the audio tokens representative of the desired audio response. At step, 416, the process can include decoding the subgroup of audio tokens to yield a reconstructed audio source. In an aspect, decoding the audio tokens can comprise decompressing the audio tokens by performing successive convolution functions in the opposing direction of the encoding performed in step 406. The decoded audio token yields a reconstructed audio file consisting with the initial text input.

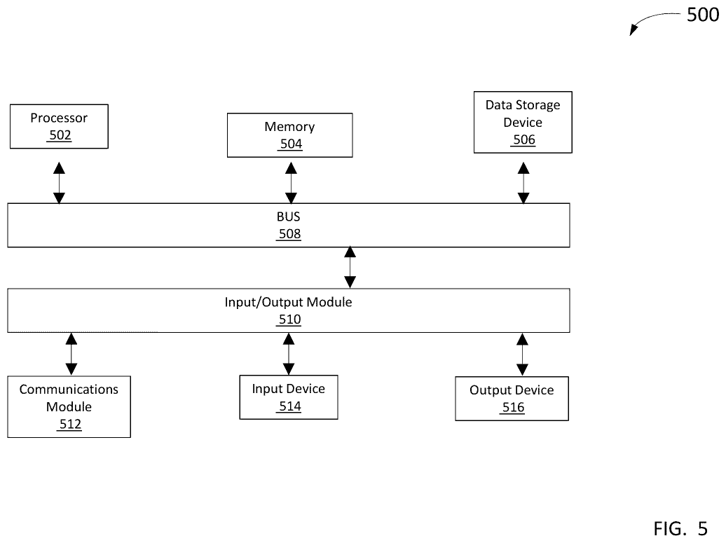

FIG. 5 is a block diagram illustrating an exemplary computer system 500 with which aspects of the subject technology can be implemented. In certain aspects, the computer system 500 may be implemented using hardware or a combination of software and hardware, either in a dedicated server, integrated into another entity, or distributed across multiple entities.

Computer system 500 (e.g., server and/or client) includes a bus 508 or other communication mechanism for communicating information, and a processor 502 coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer-readable medium for execution by, or to control the operation of, the computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device, virtual reality/augmented reality headset. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 516 include display devices such as an LCD (liquid crystal display) monitor, for displaying information to the user.

According to one aspect of the present disclosure, the above-described gaming systems can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in the main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 500 reads game data and provides a game, information may be read from the game data and stored in a memory device, such as the memory 504. Additionally, data from the memory 504 servers accessed via a network the bus 508, or the data storage 506 may be read and loaded into the memory 504. Although data is described as being found in the memory 504, it will be understood that data does not have to be stored in the memory 504 and may be stored in other memory accessible to the processor 502 or distributed among several media, such as the data storage 506.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results . The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for generating audio data, the method comprising:
receiving a text input;
receiving a plurality of representative audio sources;
encoding the plurality of audio sources into a plurality of audio tokens;
encoding the text input into a plurality of text representations;
mapping each audio tokens of the plurality of audio tokens to a text representation of the plurality of text representations;
determining a relationship score based on mapping each audio tokens to the text representation, wherein the relationship score identifies a distribution of audio tokens from the plurality of audio tokens;
in response on the relationship score, determining a subgroup of audio tokens from the distribution of audio tokens; and
decoding the subgroup of audio tokens to yield a reconstructed audio source.

2. The method of claim 1, wherein decoding the plurality of audio tokens comprises, determining a time domain loss and a frequency domain loss and implementing a Fourier transform to reduce the time domain loss and the frequency domain loss.

3. The method of claim 1, wherein decoding the subgroup of audio tokens to yield a reconstructed audio source comprises decompressing the subgroup of audio tokens.

4. The method of claim 1 wherein encoding the text input is performed by a trained text encoder model.

5. The method of claim 1 further comprising, transmitting the reconstructed audio source to a virtual reality or augment reality environment.

6. The method of claim 1 further comprising training a compression and decompression model for the plurality of audio resources based on encoding the plurality of audio resources and decoding the subgroup of audio tokens.

7. The method of claim 1 further comprising, transmitting the reconstructed audio source to a virtual reality or augment reality environment.

8. A system for generating audio data, comprising:
one or more processors;
a memory comprising instructions stored thereon, which when executed by the one or more processors, causes the one or more processors to perform:
receiving a text input;
receiving a plurality of representative audio sources;
encoding the plurality of representative audio sources into a plurality of audio tokens;
encoding the text input into a plurality of text representations;
mapping each audio tokens of the plurality of audio tokens to a text representation of the plurality of text representations;
determining a relationship score based on mapping each audio tokens to the text representation, wherein the relationship score identifies a distribution of audio tokens from the plurality of audio tokens;
in response to the relationship score, determining a subgroup of audio tokens from the distribution of audio tokens; and
decoding the subgroup of audio tokens to yield a reconstructed audio source, wherein decoding the subgroup of audio tokens to yield a reconstructed audio source comprises decompressing the subgroup of audio tokens.

9. The system of claim 8, wherein decoding the plurality of audio tokens comprises, determining a time domain loss and a frequency domain loss and implementing a Fourier transform to reduce the time domain loss and the frequency domain loss.

10. The system of claim 8, wherein encoding the text input is performed by a trained text encoder model.

11. The system of claim 8, further comprising, transmitting the reconstructed audio source to a virtual reality or augment reality environment.

12. The system of claim 8, further comprising training a compression and decompression model for the plurality of audio resources based on encoding the plurality of audio resources and decoding the subgroup of audio tokens.

13. The system of claim 8, further comprising, transmitting the reconstructed audio source to a virtual reality or augment reality environment.

14. A non-transitory storage medium comprising instructions stored thereon, which when executed by one or more processors, cause the one or more processors to perform operations for generating audio:
receiving a text input;
receiving a plurality of representative audio sources;
encoding the plurality of representative audio sources into a plurality of audio tokens;
encoding the text input into a plurality of text representations;
mapping each audio tokens of the plurality of audio tokens to a text representation of the plurality of text representations;
determining a relationship score based on mapping each audio tokens to the text representation, wherein the relationship score identifies a distribution of audio tokens from the plurality of audio tokens;
in response to the relationship score, determining a subgroup of audio tokens from the distribution of audio tokens; and
decoding the subgroup of audio tokens to yield a reconstructed audio source.

15. The non-transitory storage medium of claim 14, wherein decoding the plurality of audio tokens comprises, determining a time domain loss and a frequency domain loss and implementing a Fourier transform to reduce the time domain loss and the frequency domain loss.

16. The non-transitory storage medium of claim 14, wherein decoding the subgroup of audio tokens to yield a reconstructed audio source comprises decompressing the subgroup of audio tokens.

17. The non-transitory storage medium of claim 14, wherein encoding the text input is performed by a trained text encoder model.

18. The non-transitory storage medium of claim 14, further comprising stored sequences of instructions, which when executed by the one or more processors, cause the one or more processors to perform, transmitting the reconstructed audio source to a virtual reality or augment reality environment.

19. The non-transitory storage medium of claim 14 further comprising stored sequences of instructions, which when executed by the one or more processors, cause the one or more processors to perform training a compression and decompression model for the plurality of audio resources based on encoding the plurality of audio resources and decoding the subgroup of audio tokens.

20. The non-transitory storage medium of claim 14 further comprising stored sequences of instructions, which when executed by the one or more processors, cause the one or more processors to perform, transmitting the reconstructed audio source to a virtual reality or augment reality environment.
